(19) United States
(12) Patent Application Publication
(10) Pub. No.: US 2020/0006018 A1
(43) Pub. Date: Jan. 2, 2020

(54) REDUNDANT, PRIORITY-BASED, ROBUST GEAR SHIFTER

(71) Applicant: Byton North America Corporation, Santa Clara, CA (US)

(72) Inventor: Tajesh MAKANAWALA, Mountain View, CA (US)

(21) Appl. No.: 16/024,661

(22) Filed: Jun. 29, 2018

(51) Int. Cl. H01H 9/54; F16H 59/12

(52) U.S. Cl. CPC H01H 9/547; H01H 2231/026; F16H 59/12

(57) ABSTRACT

An analog electronic circuit, which may be used as a pushbutton electronic gear shifter circuit, is disclosed. Four pushbuttons each have a normally open pair of terminals and a normally closed pair of terminals. A first circuit outputs distinct analog voltages for presses of each of the pushbuttons. A second circuit outputs distinct pairs of analog voltages for presses of individual pushbuttons and combinations of pushbuttons.

### FIELD OF THE INVENTION

The present invention relates to the field of electronic circuits with pushbutton switches and further relates to the field of electronic circuits for vehicular transmission control.

### BACKGROUND

There are many available mechanisms for selecting park, reverse, neutral or drive in automobiles and other vehicles, including mechanical, electromechanical, electrical, and hydraulic systems, with selectors mounted on steering column, dashboard, floor or center console. Chrysler had pushbutton transmissions on cars in the 1960s, and the Fiat 500 electric car has a pushbutton transmission. Yet, typical pushbutton switches used in automotive switches in these mechanisms lack the reliability requirements for safety critical applications. Pressing multiple buttons inadvertently, or an error in a microcontroller, may result in incorrect gear shifter state, which could result in an unsafe situation. Failure of a component, a power supply, a ground line or wire in a circuit can also result in problems such as disabling the system, or incorrect selection. Therefore, there is a need in the art for a solution which overcomes the drawbacks described above.

### SUMMARY

An electronic circuit, in various embodiments, is suitable for a pushbutton electronic gear shifter and may be suitable for other applications. Multiple pushbuttons are connected through the electronic circuit to multiple analog outputs that indicate presses of the pushbuttons as detected by the electronic circuit.

An analog electronic circuit has first, second, third and fourth pushbuttons, a first, circuit and a second circuit. The first and second circuits are each resistor-based. Each of the pushbuttons has a normally open pair of terminals, and a normally closed pair of terminals.

The first circuit connects a first one of the normally open pair of terminals of each of the pushbuttons to a first output terminal. The first output terminal is to output distinct analog voltages for presses of each of the pushbuttons.

The second circuit connects a first one of the normally closed pair of terminals of each of the pushbuttons to second and third output terminals. The second and third output terminals are to output distinct pairs of analog voltages for presses of individual ones of the pushbuttons and combinations of the pushbuttons.

A pushbutton electronic circuit has first, second, third and fourth pushbuttons prioritized from highest to lowest. Each of the pushbuttons has a normally open pair of terminals that are closable, and a normally closed pair of terminals that are openable.

A first, resistor-based analog circuit connects a first one of the normally open pair of terminals of each of the pushbuttons to a first output terminal. The output terminal is to output distinct analog voltages for presses of each of the pushbuttons. The output terminal is further to ignore a lower priority pushbutton press that is simultaneous with a higher priority pushbutton press.

A second, resistor-based analog circuit connects a first one of the normally closed pair of terminals of each of the pushbuttons to second and third output terminals. The second and third output terminals are to output distinct combinations of analog voltages for presses of one, two, three or all four of the pushbuttons to identify each possibility.

A pushbutton electronic gear shifter circuit has pushbuttons, a first analog circuit and a second analog circuit. First, second, third and fourth pushbuttons each have a normally open pair of terminals that are momentarily closable, and a normally closed pair of terminals that are momentarily openable.

The first analog circuit is resistor-based and connects a first one of the normally open pair of terminals of each of the pushbuttons to a first output terminal. The first analog circuit is to output a first voltage, responsive to each of the first pushbutton being pressed alone and the first pushbutton being pressed with one, two and three others of the pushbuttons. The first analog circuit is to output a second voltage, responsive to each of the second pushbutton being pressed alone and the second pushbutton being pressed with the third, the fourth, and the third and the fourth of the pushbuttons but not the first pushbutton. The first analog circuit is to output a third voltage, responsive to each of the third pushbutton being pressed alone and the third pushbutton being pressed with the fourth pushbutton but not the first pushbutton and not the second pushbutton. The first analog circuit is to output a fourth voltage responsive to the fourth pushbutton being pressed alone.

The second analog circuit is resistor-based and connects a first one of the normally closed pair of terminals of each of the pushbuttons to second and third output terminals. The second analog circuit is to output distinct pairs of voltages responsive to conditions of button presses. The conditions of button presses include the first pushbutton alone, the second pushbutton alone, the third pushbutton alone, the fourth pushbutton alone, the first and second pushbuttons, the first and third pushbuttons, the first and fourth pushbuttons, the second and third pushbuttons, the second and fourth pushbuttons, the third and fourth pushbuttons, the first, second and third pushbuttons, the first, second and fourth pushbuttons, the first, third and fourth pushbuttons, the second, third and fourth pushbuttons, the first, second, third and fourth pushbuttons, and no pushbuttons pressed.

A method of operating a resistor-based analog circuit having four pushbuttons produces analog voltages at first, second and third output terminals. Distinct analog voltages are produced at the first output terminal to identify presses of each of the pushbuttons. The same distinct analog voltage is produced at the first output terminal for presses of a combination of one or more lower priority pushbuttons and a higher priority pushbutton as for an individual press of the higher priority pushbutton. Distinct combinations of analog voltages are produced at the second and third output terminals to identify all possible presses of one, two, three or all four of the pushbuttons.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 depicts a pushbutton electronic gear shifter circuit with analog outputs.

FIG. 2 is a system diagram with the pushbutton electronic gear shifter circuit of FIG. 1 connected through an analog bus to a transmission controller and LED indicators.

FIG. 3 is a circuit diagram for an embodiment of the pushbutton electronic gear shifter circuit of FIG. 1.

FIG. 4 is a circuit diagram for an embodiment of the comparators and logic of FIG. 2.

FIG. 5 is a flow diagram of a method of operating a resistor-based analog circuit having four pushbuttons.

### DETAILED DESCRIPTION

An analog electronic circuit described herein, in various embodiments, is used for correctly selecting a gear shifter state, and solves multiple problems in vehicular and other applications. Two resistor-based analog circuits are each independently operable in case of failure of the other, for reliable fault-tolerant operation. A first circuit prioritizes pushbutton presses, with a distinct analog output for each single pushbutton press and ignoring presses of lower priority pushbuttons that are coincident or simultaneous with a higher priority pushbutton press. A second circuit responds to single or multiple pushbutton presses, with a distinct analog output for each possibility.

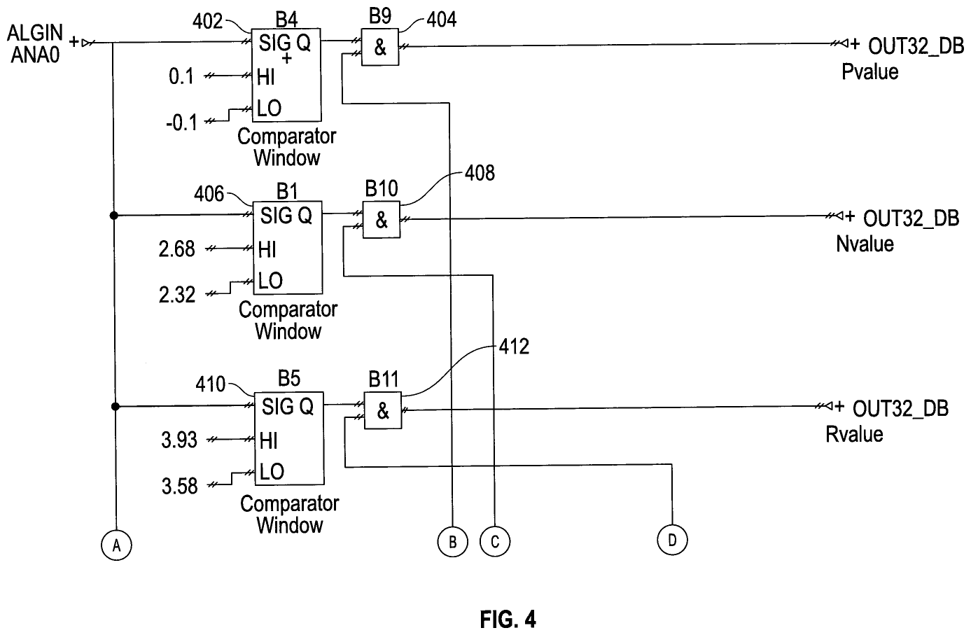

The analog electronic circuit has redundancy. In one embodiment, pushbutton switches S1, S2, S3 and S4 are redundant switches with one normally open and one normally closed contact each. Circuit one uses priority-based design to provide unique analog output. Priority order from highest to lowest is S1 (P or Park), S2 (N or neutral), S3 (R or reverse) and S4 (D or drive) in one embodiment. Resistors R1, R3, R5 and R7 are used in one embodiment (see FIG. 3) for four normally open switches to determine distinct voltage. If a lower priority switch is pressed simultaneously with a higher priority switch, then the lower priority switch press is ignored. Circuit two generates unique analog outputs for four normally closed switches using two analog outputs and resistors R2, R4, R6, R8, R9 and R10. The design can handle variation in source voltage and resistance value.

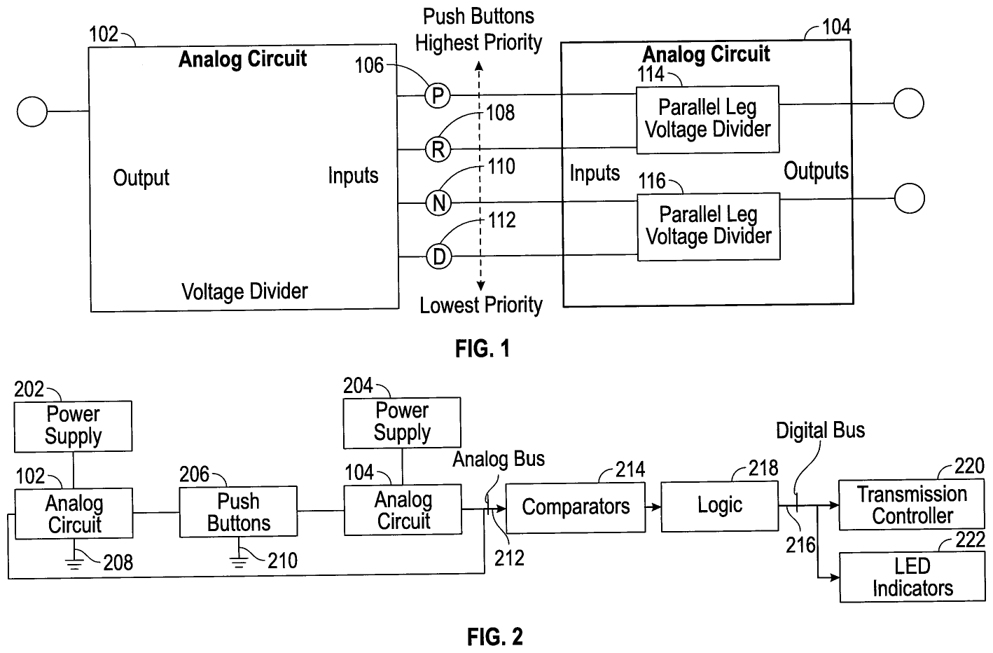

FIG. 1 depicts a pushbutton electronic gear shifter circuit with analog outputs. The circuit has two analog circuits 102, 104, both of which are connected to the pushbuttons 106, 108, 110, 112 and connect the pushbuttons to the analog outputs. In this automotive application, the pushbuttons 106, 108, 110, 112 have labels to indicate functionality for selecting the gear shifter state, but these labels could have other indications for other applications. For example, the highest priority pushbutton 106 is labeled “P” to indicate park, the second highest priority or third lowest priority pushbutton 108 is labeled “R” to indicate reverse, the third highest priority or second lowest priority pushbutton 110 is labeled “N” to indicate neutral, and the fourth highest priority or lowest priority pushbutton 112 is labeled “D” to indicate drive. Further embodiments could have other labels, functions or priorities as appropriate to a system. Pushbuttons 106, 108, 110, 112, possibly accompanied by further pushbuttons in further embodiments, could be mounted to a gear shift box, a steering column, dashboard, floor-mounted console, center-mounted console, or other structure or location in a vehicle, with labels on one of these structures or on the buttons themselves, in various embodiments. The first analog circuit 102 has a single analog voltage output, and the second analog circuit 104 has two analog voltage outputs. Further embodiments could have other numbers of analog voltage outputs, and variations could have other analog outputs such as analog current. Still further embodiments could have analog-based timing for pulses and further forms of signaling. The circuits could be extended for greater numbers of pushbuttons, for example to select a number of gears, ranges of gears, two wheel drive versus four-wheel-drive, sport mode, standard mode and economy mode operation, normal driving, assisted driving and autonomous driving modes, other operating modes or selections, etc.

For one embodiment, the first analog circuit 102 is a successive voltage divider, with stages to be activated by successive presses of individual pushbuttons. Pressing the highest priority pushbutton 106 results in the lowest analog voltage being output. Pressing the next highest priority pushbutton 108 results in a higher analog voltage being output. Pressing the third highest priority, or second lowest priority pushbutton 110 results in a still higher analog voltage being output. And, pressing the lowest priority pushbutton 112 results in a still higher analog voltage being output. The highest analog voltage is output when no pushbuttons are pressed.

For one embodiment, the second analog circuit 104 has two voltage dividers 114, 116, and each has parallel legs of differing resistance. The first parallel legs voltage divider 114 is connected to the highest priority pushbutton 106 and the second highest priority pushbutton 108. When neither pushbutton 106, 108 is pressed, the analog voltage output of the first parallel leg voltage divider 114 outputs the lowest analog voltage of that circuit. When both pushbuttons 106, 108 are pressed, the analog voltage output of the first parallel leg voltage divider 114 is the highest of that circuit. When one of the pushbuttons 106, 108 is pressed, the analog voltage output is intermediate, between the lowest and highest values. Some embodiments have differing resistance in the two legs of the parallel leg voltage divider 114, so that when one of the pushbuttons 106 is pressed, one analog voltage is output, and when the other pushbutton 108 is pressed, another, differing analog voltage is output. The first parallel leg voltage divider 114 thus puts out a distinct voltage for each possible combination of zero, one, the other, or both pushbuttons 106, 108 pressed. The second parallel leg voltage divider 116 operates similarly, for the remaining two pushbuttons 110, 112. In combination, the two parallel leg voltage dividers 114, 116 output differing pairs of analog voltages for each possible combination of presses of zero, one, two, three or four pushbuttons 106, 108, 110, 112.

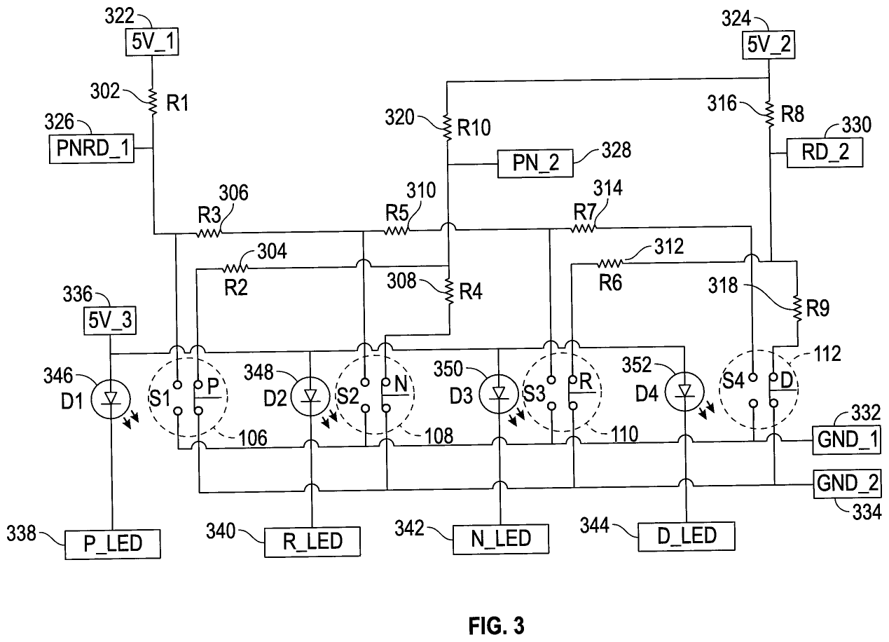

FIG. 2 is a system diagram with the pushbutton electronic gear shifter circuit of FIG. 1 connected through an analog bus 212 to a transmission controller 220 and LED indicators 222. Each of the analog circuits 102, 104 has its own power supply 202, 204 and ground connection 208, 210. If the power supply 202 for the first analog circuit 102 fails, or the ground connection 208 for the first analog circuit 102 fails, the second analog circuit 102 continues to function and determine which, if any, pushbutton or combination of pushbuttons 206 is pressed. If the power supply 204 for the second analog circuit 104 fails, or the ground connection 210 for the second analog circuit 104 fails, the first analog circuit 102 continues to function and determine if any pushbutton 206 is pressed, and if so, what is the highest priority pushbutton that is pressed. Analog voltages that are the outputs of the first and second analog circuits 102, 104 are passed along the analog bus 212 (in this embodiment, a three wire analog bus, but further embodiments could have more signal wires) towards the transmission controller 220 and LED indicators 222. To determine what analog voltage levels are present on the analog bus 212, comparators 214 receive the analog bus 212 and compare analog voltages on the analog bus 212 to various threshold voltages as specific to an implementation (e.g., depending on resistor values and power supply values). Outputs of the comparators 214 are sent to logic 218, which interprets the comparison results and sends these on a digital bus 216 to the transmission controller 220 and LED indicators 222.

For example, when one of the pushbuttons 206 is pressed, the comparators 214 and logic 218 determine which pushbutton 206 is pressed, and encode that as digital bits for the digital bus 216. The transmission controller 220 then selects the appropriate, i.e., corresponding, gear shifter state, e.g., park, reverse, neutral or drive. Relatedly, the appropriate and corresponding LED lights, in the LED indicators 222. Other indicators, such as liquid crystal display, incandescent lamps, sound, voice, image on a display panel, etc. could be used in further embodiments. When two or more of the pushbuttons 206 are pressed, the first analog circuit 102 reports the highest priority one of the pushbuttons 206 that has been pressed, and the second analog circuit 104 reports which combination of pushbuttons 206 has been pressed. The comparators 214 and logic 218 sort out this information and issue the appropriate designed-in communication to the transmission controller 220 and LED indicators 222. Whether this communication indicates an error and/or indicates a default gear shifter state is a matter of design choice specific to an implementation. Asymmetry between the first analog circuit 102 and the second analog circuit 104 supports delivery of more information about status of the pushbuttons 206 than if the first analog circuit 102 and the second analog circuit 104 were symmetric. The additional information may be useful in sorting out faults and errors for diagnostics and failsafe operation. Also, the two different types of contacts (normally open versus normally closed) used in each of the pushbuttons 206 may meet functional safety requirements and necessitate a degree of asymmetry between the first analog circuit 102 and the second analog circuit 104.

FIG. 3 is a circuit diagram for an embodiment of the pushbutton electronic gear shifter circuit of FIG. 1. The circuit is a resistor-based analog electronic circuit, with resistors 302, 306, 310, 314 connected as a successive voltage divider as described for an embodiment of analog circuit 102 in FIG. 1, resistors 304, 308, 320 connected as a parallel leg voltage divider 114, and resistors 312, 318, 316 connected as another parallel leg voltage divider 116 as described for an embodiment of analog circuit 104 in FIG. 1. Pushbuttons 106, 108, 110, 112 are labeled “S1” for switch one and “P” for park, “S2” for switch two and “N” for neutral, “S3” for switch three and “R” for reverse, and “S4” for switch four and “D” for drive, respectively. Physically, the labels could take the form of paint, stamping, embossing, molding, engraving or other form of marking on the pushbuttons 106, 108, 110, 112 or on a panel, dashboard, console, lever or other member to which the pushbuttons are mounted, etc.

Each pushbutton in this embodiment is a four terminal device and has a normally open (NO) pair of terminals that can be closed momentarily when the pushbutton is pressed, and a normally closed (NC) pair of terminals that can be opened momentarily when the pushbutton is pressed. In FIG. 3, the normally open terminals are to the left, and the normally closed terminals are to the right. The use of a four terminal switch (or set of switches) allows for redundancy, in that if one or a pair of terminals fails, the other terminal or pair of terminals may still be functional.

One way to take advantage of the redundancy offered by the four terminal pushbuttons is to use two wires per pushbutton in a digital or binary-valued circuit. One wire is for one terminal of the normally open pair of terminals, and the other wire is for one terminal of the normally closed pair of terminals. With appropriate pull-up resistors and power supply and ground connections, a binary-valued circuit with four of the four terminal pushbuttons has eight wires in a digital bus. These eight wires could then be run into an encoder, or sampled at a port of a processor or controller. In comparison, the analog electronic circuit of FIG. 3 offers advantages of fewer wires, using analog voltages, and further features for fault tolerance and fault detection.

A connection to a first ground 332, labeled “GND_1” is made to one terminal of the normally open pair of terminals of each of the pushbuttons 106, 108, 110, 112. A connection to a second ground 334, labeled “GND_2” is made to one terminal of the normally closed pair of terminals of each of the pushbuttons 106, 108, 110, 112. This way, if one of the ground connections fails, the other ground connection is still made to each of the pushbuttons, and part of the circuit can still function.

Connections are made to two power supplies 322, 324, for power supply redundancy, fault tolerance and graceful degradation of the circuit. A first power supply 322, labeled “SV_1”, provides a power supply voltage to one terminal of resistor 302 labeled “R1” for an embodiment of the first analog circuit 102 of FIG. 1. A second power supply 324, labeled “SV_2”, provides a power supply voltage to one terminal of resistor 316 labeled “R8” and to one terminal of resistor 320 labeled “R10” for an embodiment of the second analog circuit 104 of FIG. 1. If one of the power supplies 322, 324 fails, and the other power supply remains in operation, part of the circuit can still function.

Continuing with the embodiment of the first analog circuit 102, a first analog voltage output 326 labeled “PNRD_1” is at the other terminal of the resistor 302 labeled “R1”, which is also connected to one terminal of resistor 306 labeled “R3” and the other terminal of the normally open pair of terminals of the pushbutton 106 labeled “S1” and “P” in the drawing. The other terminal of resistor 306 “R3” is connected to one terminal of the resistor 310 “R5” and the other terminal of the normally open pair of terminals of the pushbutton 108 labeled “S2” and “N”. The other terminal of the resistor 310 “R5” is connected to one terminal of the resistor 314 “R7” and the other terminal of the normally open pair of terminals of the pushbutton 110 labeled “S3” and “R”. The other terminal of the resistor 314 “R7” is connected to the other terminal of the normally open pair of terminals of the pushbutton 112 labeled “S4” and “D”.

Pressing any one of the pushbuttons 106, 108, 110, 112 produces a corresponding distinct analog voltage at the first analog voltage output 326. Pressing any combination of pushbuttons 106, 108, 110, 112 produces the distinct analog voltage of the highest priority one of the pushbuttons 106, 108, 110, 112 at the first analog voltage output 326. That is, lower priority pushbuttons are ignored by the first analog circuit 102, which outputs the same analog voltage for a press of one of the pushbuttons 106, 108, 110, 112 as for a press of that pushbutton coinciding with a press of one or more lower priority pushbuttons. Table 1 is a table of values for resistors (in K ohms) for one embodiment. Table 2 is a table of analog voltages (in volts) on the first analog voltage output 326 “PNRD_1” for the first analog circuit 102 in the embodiment in FIG. 3, for presses of pushbuttons.

TABLE 1
Resistor values for first analog circuit
in FIG. 3

| | Nominal | MIN | MAX |
|---|---|---|---|
| 5_V | 5 | 4.9 | 5.1 |
| R1 | 200 | 210 | 190 |
| R3 | 200 | 190 | 210 |
| R5 | 402 | 381.9 | 422.1 |
| R7 | 806 | 765.7 | 846.3 |

TABLE 2
Voltages for first analog circuit in FIG. 3

| P | N | R | D | PNRD_1 | PNRD_1_MIN | PNRD_1_MAX |
|---|---|---|---|---|---|---|
| 0 | 0 | 0 | 0 | 5 | 4.9 | 5.1 |
| 0 | 0 | 0 | 1 | 4.378109 | 4.2351 | 4.519204028 |
| 0 | 0 | 1 | 0 | 3.753117 | 3.583975 | 3.921311276 |
| 0 | 0 | 1 | 1 | 3.753117 | 3.583975 | 3.921311276 |
| 0 | 1 | 0 | 0 | 2.5 | 2.3275 | 2.6775 |
| 0 | 1 | 0 | 1 | 2.5 | 2.3275 | 2.6775 |
| 0 | 1 | 1 | 0 | 2.5 | 2.3275 | 2.6775 |
| 0 | 1 | 1 | 1 | 2.5 | 2.3275 | 2.6775 |
| 1 | 0 | 0 | 0 | 0 | 0 | 0 |
| 1 | 0 | 0 | 1 | 0 | 0 | 0 |
| 1 | 0 | 1 | 0 | 0 | 0 | 0 |
| 1 | 0 | 1 | 1 | 0 | 0 | 0 |
| 1 | 1 | 0 | 0 | 0 | 0 | 0 |
| 1 | 1 | 0 | 1 | 0 | 0 | 0 |
| 1 | 1 | 1 | 0 | 0 | 0 | 0 |
| 1 | 1 | 1 | 1 | 0 | 0 | 0 |

0 = normally open switch is open and pushbutton is not pressed
1 = normally open switch is closed and pushbutton is pressed

Continuing next with the embodiment of the second analog circuit 104, a second analog voltage output 328 labeled “PN_2” is at the other terminal of the resistor 320 labeled “R10”, and a third analog voltage output 330 labeled “RD_2” is at the other terminal of the resistor 316 labeled “R8”. Second analog voltage output 328 “PN_2” is also connected to one terminal of resistor 304 “R2” and one terminal of resistor 308 “R4”. The other terminal of resistor 304 “R2” is connected to the other terminal of the normally closed pair of terminals of pushbutton 106 labeled “S1” and “P”. The other terminal of resistor 308 “R4” is connected to the other terminal of the normally closed pair of terminals of pushbutton 108 labeled “S2” and “N”. Third analog voltage output 330 “RD_2” is also connected to one terminal of resistor 312 “R6” and one terminal of resistor 318 “R9”. The other terminal of resistor 312 “R6” is connected to the other terminal of the normally closed pair of terminals of pushbutton 110 labeled “S3” and “R”. The other terminal of resistor 318 “R9” is connected to the other terminal of the normally closed pair of terminals of pushbutton 112 labeled “S4” and “D”.

Pressing any one of the pushbuttons 106, 108 produces a corresponding distinct analog voltage at the second analog voltage output 326. Pressing any one of the pushbuttons 110, 112 produces a corresponding distinct analog voltage at the third analog voltage output 330. Pressing both of the pushbuttons 106, 108 produces another distinct analog voltage at the second analog voltage output 326. Pressing both of the pushbuttons 110, 112 produces another distinct analog voltage at the third analog voltage output 330. Thus, pressing none, any one pushbutton, any two pushbuttons, any three pushbuttons or all four pushbuttons 106, 108, 110, 112 produces a distinct pair of analog voltages at the analog voltage outputs 326, 330, so that any combination of pushbuttons, from zero through four pushbuttons pressed, is detected by the second analog circuit 104 and identified by and indicated with a distinct pair of analog voltages. Table 3 is a table of values for resistors (in K ohms) for one embodiment. Table 4 is a table of analog voltages (in volts) on the second analog voltage output 328 “PN_2” and third analog voltage output 330 “RD_2” for the second analog circuit 104 in the embodiment in FIG. 3, for presses of pushbuttons.

TABLE 3
Resistor values for second analog circuit in FIG. 3

| | MIN | | MAX |
|---|---|---|---|
| 5_V | 5 | 4.9 | 5.1 |
| R8 = R10 | 402 | 422.1 | 381.9 |
| R9 = R4 | 402 | 422.1 | 381.9 |
| R6 = R2 | 806 | 765.7 | 846.3 |

TABLE 4
Voltages for second analog circuit in FIG. 3

| P | N | R | D | | | |
|---|---|---|---|---|---|---|
| | | | | RD_2 | RD_2_MIN | RD_2_MAX |
| | | 1 | 1 | 2.000993 | 1.920619 | 2.080564 |
| | | 1 | 0 | 3.336093 | 3.158722 | 3.514191 |
| | | 0 | 1 | 2.5 | 2.45 | 2.55 |
| | | 0 | 0 | 5 | 4.9 | 5.1 |
| | | | | PN_2 | PN_2_MIN | PN_2_MAX |
| 1 | 1 | | | 2.000993 | 1.920619 | 2.080564 |
| 1 | 0 | | | 3.336093 | 3.158722 | 3.514191 |
| 0 | 1 | | | 2.5 | 2.45 | 2.55 |
| 0 | 0 | | | 5 | 4.9 | 5.1 |

0 = normally closed switch is open and pushbutton is pressed
1 = normally closed switch is closed and pushbutton is not pressed

Referring to FIGS. 2 and 3, the first analog circuit 102 is able to discriminate among presses of each of the pushbuttons in event of failure of a second power supply 204, 324, ground line, wire or component of the second analog circuit 104. The second analog circuit 104 is able to discriminate among presses of individual ones and combinations of the pushbuttons in event of failure of a first power supply 202, 322, ground line, wire or component of the first analog circuit 102.

Further embodiments could have further branches of resistors in parallel, further resistors in series, capacitors (e.g., for RC low-pass filtering to decrease noise), active elements (e.g. operational amplifiers to make higher impedance voltage dividers, voltage followers or current mirrors, etc.), fewer or more pushbuttons and associated branches and components, other analog voltage outputs, combinations with digital or binary-valued circuits, de-bouncing circuits (e.g., cross coupled NAND gates or cross coupled NOR gates for the switches), other types of switches, fewer or more power supply and ground connections, etc. Further values for resistors and voltages are readily devised in keeping with the teachings herein. In embodiments corresponding to tables 1-4, and further embodiments with other values for resistors and power supply voltages as readily devised, the selected resistor values take into account a 2% variation in DC supply voltage and a 5% variation in resistor values for robust operation, high manufacturing yield, and tolerance to component values changing with aging.

Four LEDs (light emitting diodes) 346, 348, 350, 352 are shown in FIG. 3 as indicator lamps, powered by a third power supply 336 labeled “SV_3”. The first LED 346 labeled “D1” is activated by a first LED control terminal 338 labeled “P_LED”. The second LED 348 labeled “D2” is activated by a second LED control terminal 340 labeled “R_LED”. The third LED 350 labeled “D3” is activated by a third LED control terminal 342 labeled “N_LED”. The fourth LED 352 labeled “D4” is activated by a fourth LED control terminal 344 labeled “D_LED”. Control signals for the control terminals could be generated by a circuit that interprets the analog voltages produced at the analog voltage outputs 326, 328, 330, for example including comparators or an analog to digital converter (ADC). In further embodiments, other output indicators such as incandescent lamps, liquid crystal displays, etc. could be used (see description for FIG. 2 LED indicators 222).

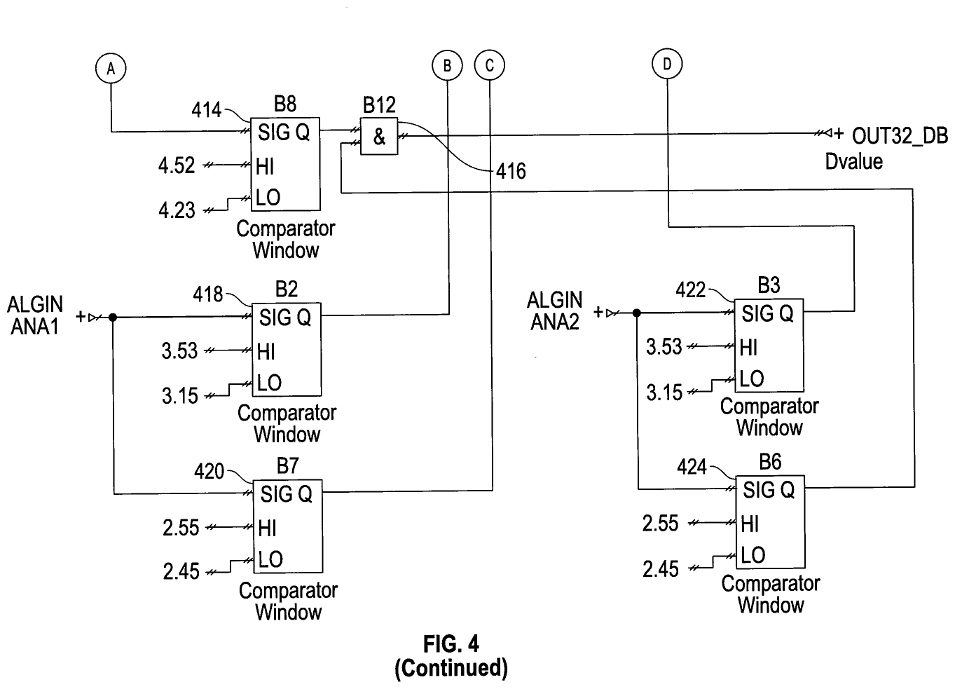

FIG. 4 is a circuit diagram for an embodiment of the comparators 214 and logic 218 of FIG. 2. Comparators 402, 406, 410, 414, 418, 420, 422, 424 each have a comparator window and detect an analog voltage within a specified range of voltages. Logic gates 404, 408, 412, 416 combine outputs of specific comparators and produce digital outputs that indicate a specific transmission state, for example for use with the LED indicators 222 and/or transmission controller 220 of FIG. 2. Comparator 402 detects an analog voltage in a range of −0.3 to 0.3 on analog input labeled “ANA0”, which is the output of analog circuit 102 of FIG. 2 or analog voltage output 326 “PNRD_1” of FIG. 3, in various embodiments. Comparator 406 detects an analog voltage in the range of 2.32 to 2.68 on the analog input “ANA0”. Comparator 410 detects an analog voltage in the range of 3.58 to 3.93 on the analog input “ANA0”. Comparator 414 detects an analog voltage in the range of 4.23 to 4.52 on the analog input “ANA0”.

Comparator 418 detects an analog voltage in the range of 3.15 to 3.53 on the analog input “ANA1”. Comparator 420 detects an analog voltage in the range of 2.45 to 2.55 on the analog input “ANA1”. Comparator 422 detects an analog voltage in the range of 3.15 to 3.53 on the analog input “ANA2”. Comparator 424 detects an analog voltage in the range of 2.45 to 2.55 on the analog input “ANA2”.

Logic gate 404 performs a logical AND on outputs of comparators 402, 418 to form output “OUT32_DB Pvalue”. Logic gate 408 performs a logical AND on outputs of comparators 406, 420 to form output “OUT32_DB Nvalue”. Logic gate 412 performs a logical AND on outputs of comparators 410, 422 to form output “OUT32_DB Rvalue”. Logic gate 416 performs a logical AND on outputs of comparators 414, 424 to form output “OUT32_DB Dvalue”. Comparators 402, 406, 410, 414, 418, 420, 422, 424 and logic gates 404, 408, 412, 416 thus detect and indicate a press of a pushbutton 106, 108, 110, 112.

Further logic could detect various faults. Various comparator window ranges could be used for various resistor values in the circuit. In a further embodiment, analog voltages are sampled by one or more analog-to-digital converters, and detection of analog voltages in ranges, followed by logical combinations of the detections, is performed by a processor. In various embodiments, a processor or logic gates could perform fault detection to detect, e.g., when a pushbutton is stuck, two or more pushbuttons are pressed, a power supply or a ground connection fails, and other faults.

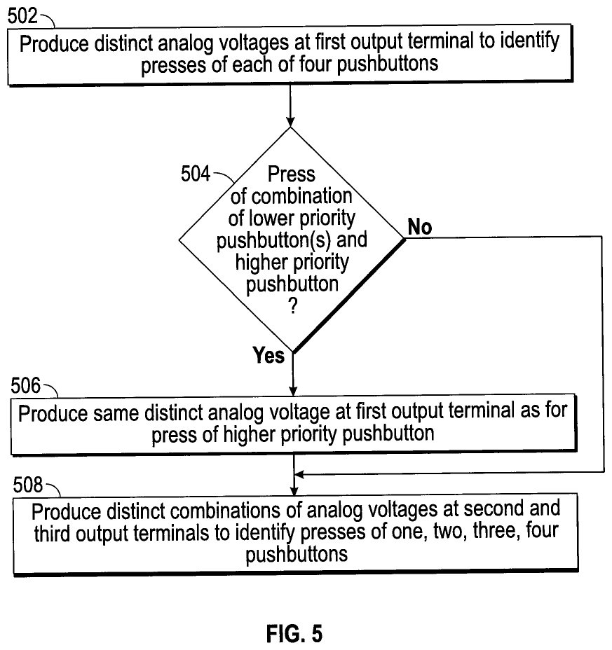

FIG. 5 is a flow diagram of a method of operating a resistor-based analog circuit having four pushbuttons. The method can be practiced by embodiments of analog circuits described herein. In an action 502, distinct analog voltages are produced at the first output terminal, to identify presses of each of four pushbuttons. By distinct analog voltages, it is meant that each pushbutton, when pressed, produces an analog voltage that differs, or is distinct from, the analog voltage produced when any other pushbutton is pressed.

In an action 504, it is determined whether there is a press of a combination of one or more lower priority pushbuttons and a higher priority pushbutton. If the answer is no, there is no such press of a combination of pushbuttons, flow proceeds to the action 508. If the answer is yes, there is a press of a combination of one or more lower priority pushbuttons and a higher priority pushbutton, flow proceeds to the action 506. In the action 506, the same distinct analog voltage is produced at the first output terminal as for a press of the higher priority pushbutton alone.

In an action 508, distinct combinations of analog voltages are produced at the second and third output terminals to identify presses of one, two, three or four pushbuttons. By distinct combinations of analog voltages, it is meant that each possible press of any number of the pushbuttons produces analog voltages at the second and third output terminals that, in combination, differ from or are distinct from the analog voltages at the second and third output terminals for any other possible press of one or more of the pushbuttons.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein.

What is claimed is:

1. An analog electronic circuit, comprising:
first, second, third and fourth pushbuttons, each having a normally open pair of terminals and a normally closed pair of terminals;
a first, resistor-based circuit connecting a first one of the normally open pair of terminals of each of the pushbuttons to a first output terminal to output distinct analog voltages for presses of each of the pushbuttons; and
a second, resistor-based circuit connecting a first one of the normally closed pair of terminals of each of the pushbuttons to second and third output terminals to output distinct pairs of analog voltages for presses of individual ones and combinations of the pushbuttons.

2. The analog electronic circuit of claim 1, wherein:
the pushbuttons are prioritized from first as highest to fourth as lowest priority; and
the first resistor-based circuit is to output a same analog voltage for a press of one of the pushbuttons as for a press of the one of the pushbuttons coinciding with a press of one or more of lower priority ones of the pushbuttons.

3. The analog electronic circuit of claim 1, wherein the first, resistor-based circuit comprises:
a first resistor connected between a first power supply terminal and the first output terminal;
a third resistor connected between the first one of the normally open terminals of each of the first and second pushbuttons;
a fifth resistor connected between the first one of the normally open terminals of each of the second and third pushbuttons; and
a seventh resistor connected between the first one of the normally open terminals of each of the third and fourth pushbuttons.

4. The analog electronic circuit of claim 1, wherein the second, resistor-based circuit comprises:
a tenth resistor connected between a second power supply terminal and the second output terminal;
a second resistor connected between the first one of the normally open terminals of the first pushbutton and the second output terminal;
a fourth resistor connected between the first one of the normally open terminals of the second pushbutton and the second output terminal;
an eighth resistor connected between the second power supply terminal and the third output terminal;
a sixth resistor connected between the first one of the normally open terminals of the third pushbutton and the third output terminal; and
a ninth resistor connected between the first one of the normally open terminals of the fourth pushbutton and the third output terminal.

5. The analog electronic circuit of claim 1, wherein:
the first, resistor-based circuit is able to discriminate among presses of each of the pushbuttons in event of failure of a second power supply, wire or component of the second, resistor-based circuit; and
the second, resistor-based circuit is able to discriminate among the presses of individual ones and combinations of the pushbuttons in event of failure of a first power supply, wire or component of the first, resistor-based circuit.

6. The analog electronic circuit of claim 1, further comprising:
the first and second resistor-based circuits having separate ground lines so that one of the first and second resistor-based circuits is to remain operable in event of failure of one of the ground lines.

7. The analog electronic circuit of claim 1, wherein:
the first, resistor-based circuit is arranged as a successive voltage divider to be activated by successive presses of individual ones of the pushbuttons; and
the second, resistor-based circuit is arranged as a pair of voltage dividers each having parallel legs to two of the pushbuttons.

8. A pushbutton electronic circuit, comprising:
first, second, third and fourth pushbuttons, prioritized from highest to lowest, each having a normally open pair of terminals that are closable and a normally closed pair of terminals that are openable;
a first, resistor-based analog circuit connecting a first one of the normally open pair of terminals of each of the pushbuttons to a first output terminal to output distinct analog voltages for presses of each of the pushbuttons and to ignore a lower priority pushbutton press that is simultaneous with a higher priority pushbutton press; and
a second, resistor-based analog circuit connecting a first one of the normally closed pair of terminals of each of the pushbuttons to second and third output terminals to output distinct combinations of analog voltages for presses of one, two, three or all four of the pushbuttons to identify each possibility.

9. The pushbutton electronic circuit of claim 8, wherein the first, resistor-based analog circuit comprises:
a first resistor connected to a first power supply terminal and the first output terminal;
a third resistor connected to the first one of the normally open terminals of the first pushbutton and the first one of the normally open terminals of the second pushbutton;
a fifth resistor connected to the first one of the normally open terminals of the second pushbutton and the first one of the normally open terminals of the third pushbutton; and
a seventh resistor connected to the first one of the normally open terminals of the third pushbutton and the first one of the normally open terminals of the fourth pushbutton.

10. The pushbutton electronic circuit of claim 8, wherein the second, resistor-based analog circuit comprises:
a tenth resistor connected to a second power supply terminal and the second output terminal;
a second resistor connected to the first one of the normally open terminals of the first pushbutton and the second output terminal;
a fourth resistor connected to the first one of the normally open terminals of the second pushbutton and the second output terminal;
an eighth resistor connected to the second power supply terminal and the third output terminal;
a sixth resistor connected to the first one of the normally open terminals of the third pushbutton and the third output terminal; and
a ninth resistor connected to the first one of the normally open terminals of the fourth pushbutton and the third output terminal.

11. The pushbutton electronic circuit of claim 8, wherein:
the first, resistor-based analog circuit is connected to discriminate among presses of each of the pushbuttons in event of failure of each of a second power supply, a wire and a component of the second, resistor-based analog circuit; and
the second, resistor-based analog circuit is connected to discriminate among the presses of individual ones and combinations of the pushbuttons in event of failure of each of a first power supply, a wire and a component of the first, resistor-based analog circuit.

12. The pushbutton electronic circuit of claim 8, further comprising:
the first resistor-based analog circuit having a first ground line; and
the second resistor-based analog circuit having a separate, second ground line, so that the first resistor-based analog circuit remains operable in event of failure of the second ground line and the second resistor-based analog circuit remains operable in event of failure of the first ground line.

13. The pushbutton electronic circuit of claim 8, wherein:
the first, resistor-based analog circuit is connected as a resistive voltage divider having a plurality of stages to be activated by successive presses of individual ones of the pushbuttons; and
the second, resistor-based analog circuit is connected as a pair of resistive voltage dividers each having parallel legs of differing resistance to two of the pushbuttons.

14. The pushbutton electronic circuit of claim 8, further comprising:
a plurality of comparators, each having a comparator voltage window to detect one of the distinct analog voltages from the first output terminal or an analog voltage of one of the distinct combinations of analog voltages from the second and third output terminals.

15. A pushbutton electronic gear shifter circuit, comprising:
first, second, third and fourth pushbuttons, each having a normally open pair of terminals that are momentarily closable and a normally closed pair of terminals that are momentarily openable;
a first, resistor-based analog circuit connecting a first one of the normally open pair of terminals of each of the pushbuttons to a first output terminal to output:
a first voltage responsive to each of the first pushbutton being pressed alone and the first pushbutton being pressed with one, two, and three others of the pushbuttons;
a second voltage responsive to each of the second pushbutton being pressed alone and the second pushbutton being pressed with the third, the fourth, and the third and the fourth of the pushbuttons but not the first pushbutton;
a third voltage responsive to each of the third pushbutton being pressed alone and the third pushbutton being pressed with the fourth pushbutton but not the first pushbutton and not the second pushbutton; and
a fourth voltage responsive to the fourth pushbutton being pressed alone; and
a second, resistor-based analog circuit connecting a first one of the normally closed pair of terminals of each of the pushbuttons to second and third output terminals to output distinct pairs of voltages responsive to conditions of button presses comprising the first pushbutton alone, the second pushbutton alone, the third pushbutton alone, the fourth pushbutton alone, the first and second pushbuttons, the first and third pushbuttons, the first and fourth pushbuttons, the second and third pushbuttons, the second and fourth pushbuttons, the third and fourth pushbuttons, the first, second and third pushbuttons, the first, second and fourth pushbuttons, the first, third and fourth pushbuttons, the second, third and fourth pushbuttons, the first, second, third and fourth pushbuttons, and no pushbuttons pressed.

16. The pushbutton electronic gear shifter circuit of claim 15, wherein the first, resistor-based analog circuit and the second, resistor-based analog circuit in combination comprise:
a first resistor having a first terminal connected to a first power supply terminal and a second terminal connected to the first output terminal;
a third resistor having a first terminal connected to the first one of the normally open terminals of the first pushbutton and a second terminal connected to the first one of the normally open terminals of the second pushbutton;
a fifth resistor having a first terminal connected to the first one of the normally open terminals of the second pushbutton and a second terminal connected to the first one of the normally open terminals of the third pushbutton;
a seventh resistor having a first terminal connected to the first one of the normally open terminals of the third pushbutton and a second terminal connected to the first one of the normally open terminals of the fourth pushbutton;
a tenth resistor having a first terminal connected to a second power supply terminal and a second terminal connected to the second output terminal;
a second resistor having a first terminal connected to the first one of the normally open terminals of the first pushbutton and a second terminal connected to the second output terminal;
a fourth resistor having a first terminal connected to the first one of the normally open terminals of the second pushbutton and a second terminal connected to the second output terminal;
an eighth resistor having a first terminal connected to the second power supply terminal and a second terminal connected to the third output terminal;
a sixth resistor having a first terminal connected to the first one of the normally open terminals of the third pushbutton and a second terminal connected to the third output terminal; and
a ninth resistor having a first terminal connected to the first one of the normally open terminals of the fourth pushbutton and a second terminal connected to the third output terminal.

17. The pushbutton electronic gear shifter circuit of claim 15, wherein:
the first, resistor-based analog circuit is connected to discriminate among presses of each of the pushbuttons in event of failure of each of a ground line, a wire and a component of the second, resistor-based analog circuit, and a second power supply coupled to the second, resistor-based analog circuit; and
the second, resistor-based analog circuit is connected to discriminate among the presses of individual ones and combinations of the pushbuttons in event of failure of each of a ground line, a wire and a component of the first, resistor-based analog circuit, and a first power supply coupled to the first, resistor-based analog circuit.

18. The pushbutton electronic gear shifter circuit of claim 15, wherein:
the first, resistor-based analog circuit is connected as a resistive voltage divider having a plurality of resistive stages connected to the pushbuttons to be activated by successive presses of individual ones of the pushbuttons; and
the second, resistor-based analog circuit is connected as a first resistive voltage divider having parallel legs of differing resistance connected to the first and second pushbuttons and a second resistive voltage divider having parallel legs of differing resistance connected to the third and fourth pushbuttons.

19. The pushbutton electronic gear shifter circuit of claim 15, further comprising:
a plurality of comparators, each having a comparator voltage window to detect one of the first, second, third or fourth voltages from the first output terminal or a voltage from one of the second and third output terminals outputting the distinct pairs of voltages.

20. The pushbutton electronic gear shifter circuit of claim 15, further comprising:
the first pushbutton labeled to indicate park;
the second pushbutton labeled to indicate neutral;
the third pushbutton labeled to indicate reverse; and
the fourth pushbutton labeled to indicate drive.

21. A method of operating a resistor-based analog circuit having four pushbuttons, comprising:
producing distinct analog voltages at a first output terminal to identify presses of each of the pushbuttons;
producing a same distinct analog voltage at the first output terminal for presses of a combination of one or more lower priority pushbuttons and a higher priority pushbutton as for an individual press of the higher priority pushbutton; and
producing distinct combinations of analog voltages at second and third output terminals to identify all possible presses of one, two, three or all four of the pushbuttons.

22. The method of claim 1, further comprising:
discriminating among presses of each of the pushbuttons through a first portion of the resistor-based analog circuit despite failure of a power supply, ground connection, wire or component of a second portion of the resistor-based analog circuit.

23. The method of claim 1, further comprising:
discriminating among presses of individual ones and combinations of two, three and four of the pushbuttons through a second portion of the resistor-based analog circuit despite failure of a power supply, ground connection, wire or component of a first portion of the resistor-based analog circuit.

24. The method of claim 1, further comprising:
detecting the distinct analog voltages at the first output terminal and the distinct combinations of analog voltages at the second and third output terminals, through a plurality of comparators.
